(19) United States
(12) Patent Application Publication
(10) Pub. No.: US 2025/0305442 A1
(43) Pub. Date: Oct. 2, 2025

(54) METHOD AND SYSTEM FOR DIRECT HYDROGEN FUEL INJECTION OF COMBUSTION ENGINE

(71) Applicant: Cosmic Energy Power Inc., Springville, NY (US)

(72) Inventors: Frederick M. Heary, Springville, NY (US); Frederick F. Heary, Springville, NY (US)

(73) Assignee: Cosmic Energy Power Inc., Springville, NY (US)

(21) Appl. No.: 18/623,290

(22) Filed: Apr. 1, 2024

(51) Int. Cl. F02M 27/04; F01N 3/00; F02M 37/00; F02M 37/04

(52) U.S. Cl. CPC F02B 43/10; C25B 1/04; F01N 3/005; F02M 21/0206; F02M 25/12; F02M 27/04; F02M 37/04; F02B 2043/106; Y02E 60/36; Y02T 10/30

(57) ABSTRACT

A hydrogen fuel injection system can include a vessel having a fuel source inlet for receiving fuel, at least one electrically conductive mass within the vessel for providing increased surface area to the fuel, a first electrode having a first polarization coupled to the at least one electrically conductive mass, a second electrode having an opposite polarization from the first polarization and coupled to the at least one electrically conductive mass, wherein the first electrode and second electrode are arranged and constructed to break down the fuel into hydrogen and oxygen when a power source applies a voltage across the first electrode and second electrode, a non-conductive barrier that at least partially isolates the first electrode from the second electrode, and at least a first outlet coupled to the vessel serving as a hydrogen fuel outlet to a combustion engine.

### FIELD

The present disclosure is directed to a method for an injection system for the use in combustion engines that performs the separation of water molecules into the combustible fuels hydrogen and oxygen, and more particularly to an environmentally friendly method and system of carbon free fuel utilization by combustion engines and home/industrial heating units.

### BACKGROUND

Current methods of fuel are largely comprised of carbon emitting fuels that have been shown to have large negative impacts on the environment. Even alternative sources of fuel such as hydrogen fuel and methods of generating such fuels can have drawbacks.

Furthermore, many existing systems for generating hydrogen fuel utilize chemicals that end up emitting gases that are environmentally unfriendly or use energy as an input that is environmentally damaging (e.g., coal-fired electricity generation).

### SUMMARY

In some embodiments the hydrogen fuel injection system will contain an electronic computer module (ECM) or processor that will regulate the amount of electric current flowing through the unit which in turn will either increase or decrease the amount of hydrogen fuel that is being produced.

In some embodiments the hydro fuel injection system will include a variable pressure fuel pump that can increase or decrease the flow of water to the unit which will be regulated by the ECM.

In some embodiments the hydro fuel injection system may use a Capacitor Discharge Ignition (CDI) box, high voltage ignition coil, or ECM to deliver the electric charge to the vessel that contains the water that is being converted to the Hydrogen and Oxygen fuels.

In some embodiments the hydro fuel injection system may use a step-up or boost converter to generate the desired voltages for the electrolysis process.

In some embodiments the hydro fuel injection system may have variable voltage requirements based on the fuel output needs.

In some embodiments one unit may be sufficient as the fuel delivery system.

In some embodiments multiple units may be required as the fuel delivery system.

In some embodiments the units will be used as the fuel delivery system for combustion engines.

In some embodiments the units will be used as the fuel delivery system for commercial or residential heating units.

In some embodiments an electrolytic solution may need to be added to the water to enhance the electrolysis process.

In some embodiments an electrolytic additive may need to be added to the water to keep the water from freezing in cold climates.

In some embodiments an additional replaceable anode cartridge will be added to the vessel for the purpose of cleaning the anode outlet tube through a reverse electrolysis process. This process will be regulated through the ECM based on loss of efficiency.

In some embodiments, a hydrogen fuel injection system can include a vessel having a fuel source inlet for receiving fuel from a fuel source, at least one electrically conductive mass within the vessel for providing increased surface area to the fuel, a first electrode having a first polarization coupled to the at least one electrically conductive mass, a second electrode having an opposite polarization from the first polarization and coupled to the at least one electrically conductive mass, wherein the first electrode and second electrode are arranged and constructed to break down the fuel into hydrogen and oxygen when a power source applies a voltage across the first electrode and second electrode, a non-conductive barrier that at least partially isolates the first electrode from the second electrode, and at least a first outlet coupled to the vessel serving as a hydrogen fuel outlet to a combustion engine.

In some embodiments, the first electrode is an anode and the fuel is water. In some embodiments, the second electrode is a cathode and the fuel source is water. In some embodiments, the first electrode is an anode, the second electrode is a cathode, and the fuel is water. In some embodiments, the vessel is conductive and the cathode is electrically coupled to the vessel.

In some embodiments, the first electrode is an anode, the second electrode is a cathode, and the fuel is water and at least the first fuel outlet is formed from the anode. In some embodiments, the first fuel outlet further includes a one way valve only allowing fluid out of the first fuel outlet.

In some embodiments, the at least one electrically conductive mass is a porous metal material. In some embodiments, the electrically conductive mass is a porous conductive anode material.

In some embodiments, the first electrode is an anode, the second electrode is a cathode, the fuel is water, and the vessel includes a first vessel portion substantially electrically isolated from the a second vessel portion using the non-conductive barrier, where the at least one electrically conductive mass is coupled to the cathode within the first vessel portion to enable hydrogen fuel generation and where a second electrically conductive mass is coupled to the anode within the second vessel portion to enable oxygen generation.

In some embodiments, the first electrode is an anode, the second electrode is a cathode, the fuel is water, and the cathode is further configured to serve as a portion of a hydrogen fuel outlet and the anode is further configured to serve as a oxygen outlet. In some embodiments,

In some embodiments, the system further includes a one way valve for each of the hydrogen fuel outlet, the oxygen outlet and the fuel source inlet.

In some embodiments, the hydrogen fuel injection system is a portion of a hydrogen fuel injection combustion engine system including a fuel tank that supplies the hydrogen fuel injection system via a pump, a power source coupled to the hydrogen fuel injection system, a combustion engine coupled to the hydrogen fuel injection system, and a processor coupled to the pump, power source, and hydrogen fuel injection system, where the processor regulates at least the pressure provided by the pump and the current or voltage provided by the power source to the hydrogen fuel injection system.

In some embodiments, the hydrogen fuel injection combustion engine system further comprises an exhaust condensation chamber coupled to a second pump that feeds condensation back to the fuel tank and wherein the processor is further coupled to the second pump to control the pressure provided by the second pump.

In some embodiments, a hydrogen fuel injection system can include a vessel having a fuel source inlet for receiving fuel from a fuel source containing water a first electrically conductive mass within a first vessel portion of the vessel for providing increased surface area to the fuel, a second electrically conductive mass within a second vessel portion of the vessel, a cathode coupled to the first electrically conductive mass, and an anode coupled to the second electrically conductive mass. In some embodiments, the cathode and anode are arranged and constructed to break down the water into hydrogen and oxygen when a power source applies a voltage across the cathode and anode where system further includes a non-conductive barrier that at least partially isolates the cathode from the anode, a first outlet at least formed partially from the cathode and coupled to the first vessel portion serving as a hydrogen fuel outlet to a combustion engine, and a second outlet at least formed partially from the anode and coupled to the second vessel portion serving as an oxygen outlet.

In some embodiments, the first vessel portion and the second vessel portion are porous.

In some embodiments, a hydrogen fuel injection combustion engine system can include a fuel tank configured for holding fuel containing at least water, a hydrogen fuel injection system coupled to the fuel tank where the hydrogen fuel injection system generates hydrogen via electrolysis, a pump coupled between the fuel tank and the hydrogen fuel injection system and configured to drive fuel from the fuel tank to the hydrogen fuel injection system, a power source coupled to the hydrogen fuel injection system, a hydrogen fuel combustion engine coupled to the hydrogen fuel injection system, and a processor coupled to the pump, the power source, and the hydrogen fuel injection system, where the processor regulates at least the pressure provided by the pump and the current or voltage provided by the power source to the hydrogen fuel injection system.

In some embodiments, the hydrogen fuel injection combustion engine system further includes an exhaust condensation chamber coupled to a second pump that feeds condensation back to the fuel tank and wherein the processor is further coupled to the second pump to control the pressure provided by the second pump.

In some embodiments, the hydrogen fuel injection system includes an anode and a cathode, and where at least a fuel outlet formed from the anode or the cathode of the hydrogen fuel injection system at least partially serves as an inlet to the hydrogen fuel combustion engine.

In some embodiments, the hydrogen fuel injection system above can further include a vessel having a fuel source inlet for receiving fuel from the fuel tank containing water, a first electrically conductive mass within a first vessel portion for providing increased surface area to the fuel, a second electrically conductive mass within a second vessel portion, a cathode coupled to the first electrically conductive mass, an anode coupled to the second electrically conductive mass, where the cathode and anode are arranged and constructed to break down the water into hydrogen and oxygen when a power source applies a voltage across the cathode and anode. The hydrogen fuel injection system can further include a non-conductive barrier that at least partially isolates the cathode from the anode, a first outlet at least partially formed from the cathode and coupled to the first vessel portion serving as a hydrogen fuel outlet to the hydrogen combustion engine, and a second outlet at least partially formed from the anode and coupled to the second vessel portion serving as an oxygen outlet.

### BRIEF DESCRIPTION OF DRAWINGS

FIG. 1A illustrates a system for generating hydrogen fuel from water using electrolysis using an anode that also serves as a portion of fuel outlet from a hydrogen fuel injection system in accordance with the embodiments.

FIG. 1B Illustrates another system similar to the system of FIG. 1A for generating hydrogen fuel from water using electrolysis in accordance with the embodiments.

FIG. 2 illustrates a hydrogen fuel injection system having a first vessel portion and cathode and a separate second vessel portion and anode in accordance with the embodiments;

FIG. 3A illustrates a hydrogen fuel injection and combustion engine in accordance with the embodiments;

FIG. 3B illustrates a hydrogen fuel injection and combustion engine similar to the engine of FIG. 3A and further including ah exhaust condensation chamber in accordance with the embodiments;

FIG. 4 illustrates a hydrogen fuel injection and combustion engine utilized in a vehicle in accordance with the embodiments.

### DETAILED DESCRIPTION OF DRAWINGS

The system that is being proposed will create a fuel delivery system that will not have a carbon footprint or one that is significantly less than current fuel systems and can be widely used in the industries that require combustion engines for operations or gas heating units used in commercial or residential applications. Examples include, but are not limited to, electric power manufacturing facilities, transportation, agriculture, residential, and many others that currently rely on environmentally unfriendly carbon-based fuels.

Utilizing Hydrogen fuel instead of carbon-based fuels is clean and practical as using hydrogen as fuel is similar to that of carbon fuels with the exception that the byproducts of hydrogen fuel are heat and water.

The reaction for forming water can be demonstrated by the chemical formula:

2H2(g)+O2(g)→2H2O(l)

The explanation of this chemical formula is as follows:

Two Hydrogen gas molecules combined with Two Oxygen gas molecules yields Two water molecules in liquid form.

The fuel delivery system that is being proposed will take water and separate it into hydrogen and oxygen through water electrolysis which then will be used as a fuel in combustion engines.

The reaction for forming hydrogen fuel from water can be demonstrated by the chemical formula:

2H2O(I)+electric current→2H2(g)+02(g)

The explanation of this chemical formula is as follows:

Two water molecules in liquid form submitted to an electric current yields two Hydrogen gas molecules and two Oxygen molecules.

The Hydrogen Fuel Injection system that is being proposed will take water and separate it into hydrogen and oxygen which then can be used as a fuel in combustion engines.

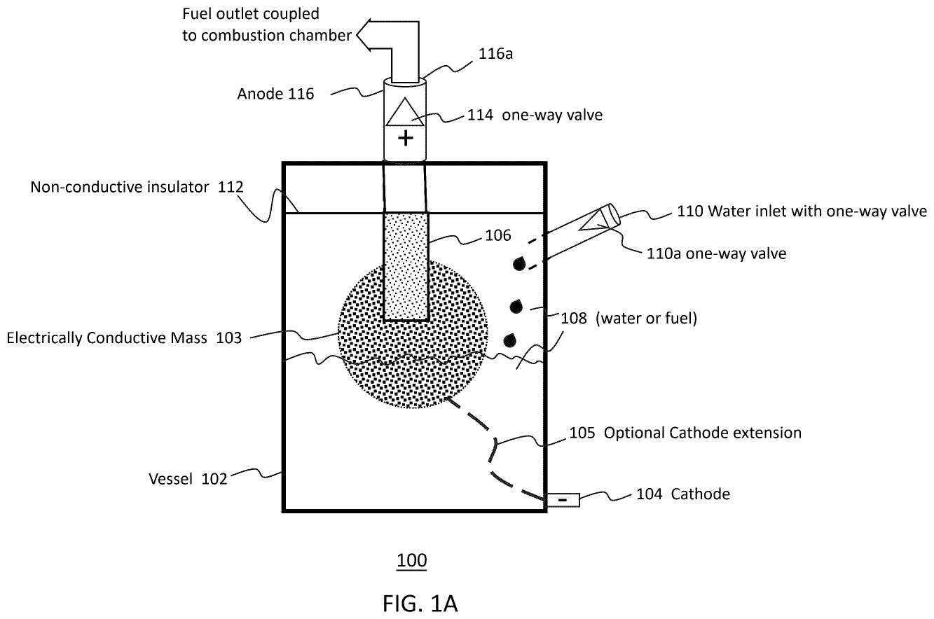

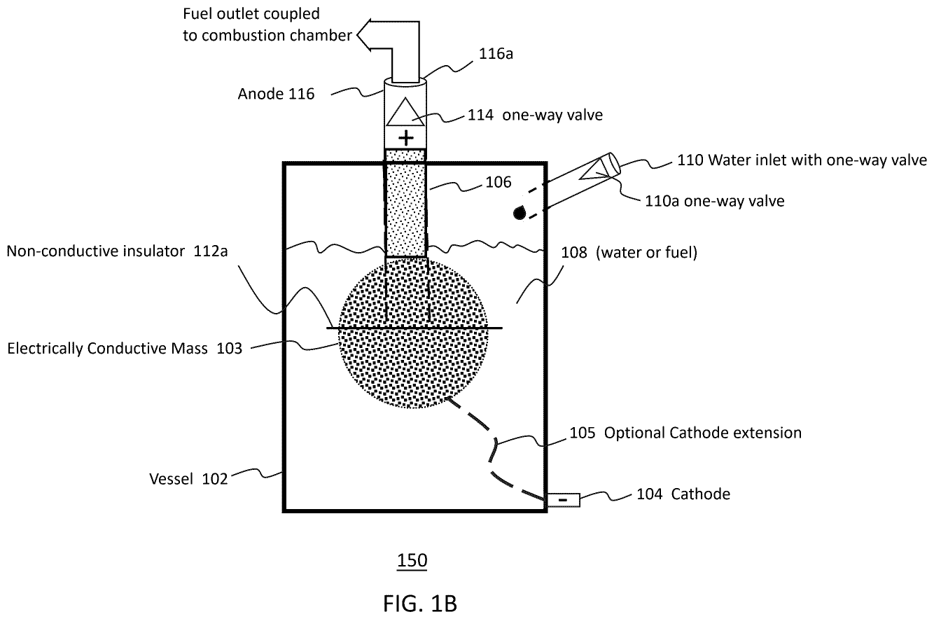

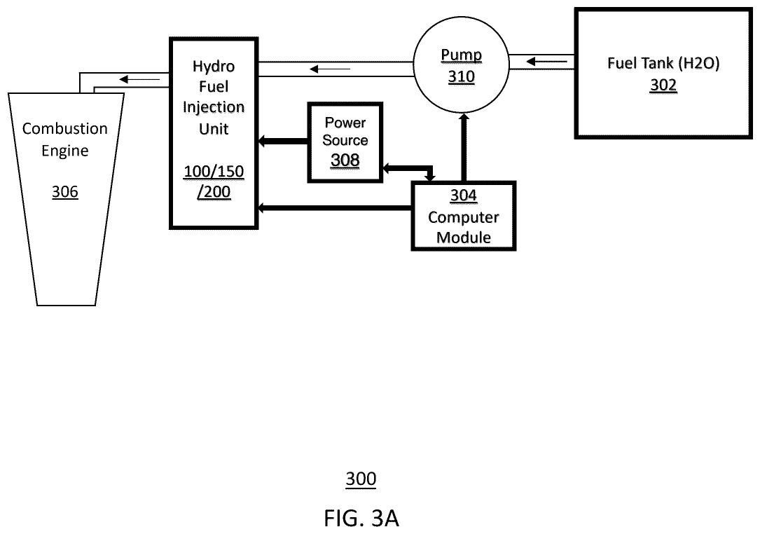

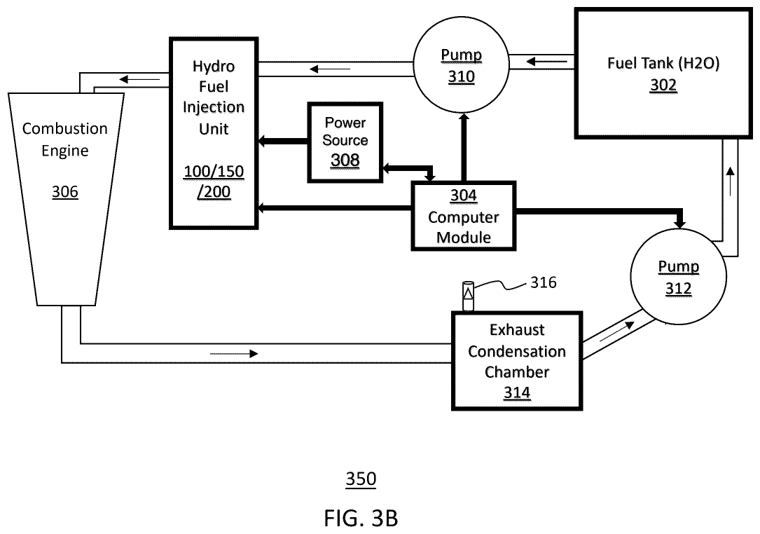

FIG. 1A in accordance with some embodiments depicts a hydrogen fuel injection system 100 having a vessel 102 having a fuel source inlet 110 for receiving fuel 108 from a fuel source, at least one electrically conductive mass 103 within the vessel 102 for providing increased surface area to the fuel 108, a first electrode 116 having a first polarization (such as + for an anode) coupled to the at least one electrically conductive mass 103, a second electrode 104 having an opposite polarization from the first polarization (such as—for a cathode) and coupled to the at least one electrically conductive mass 103, where the first electrode 116 and second electrode 104 are arranged and constructed to break down the fuel 108 into hydrogen and oxygen when a power source (such as power source 308 in FIG. 3) applies a voltage across the first electrode and second electrodes, a non-conductive barrier 112 that at least partially isolates the first electrode 116 from the second electrode 104, and at least a first outlet 116a coupled to the vessel 102 serving as a hydrogen fuel outlet to a combustion engine (see 306 in FIG. 3).

In some embodiments, the first electrode 116 is an anode and the fuel 110 is water. In some embodiments, an electrolytic solution can be added to the water to enhance the electrolysis process. In some embodiments, an electrolytic additive can be added to the water to prevent the water from freezing in cold climates. In some embodiments, the second electrode 104 is a cathode and the fuel 108 is water. In some embodiments, the first electrode 116 is an anode, the second electrode 104 is a cathode, and the fuel 108 is water. In some embodiments, the vessel 102 is conductive and the cathode 104 is electrically coupled to the vessel 102. In some embodiments, a direct connection 105 can be made between the electrode 104 and the electrically conductive mass 103.

In some embodiments, the first electrode 116 is an anode, the second electrode 104 is a cathode, and the fuel 108 is water and at least the first fuel outlet116a is formed from the anode. In some embodiments, the first fuel outlet 116a further includes a one way valve 114 only allowing fluid out of the first fuel outlet 116a.

In some embodiments, the at least one electrically conductive mass 103 is a porous metal material such as metal mesh or metal sponge. In some embodiments, the electrically conductive mass 103 is a porous conductive anode material. In some embodiments, the porous anode material can be a silicon based anode material or other porous materials known to provide adequate conductivity.

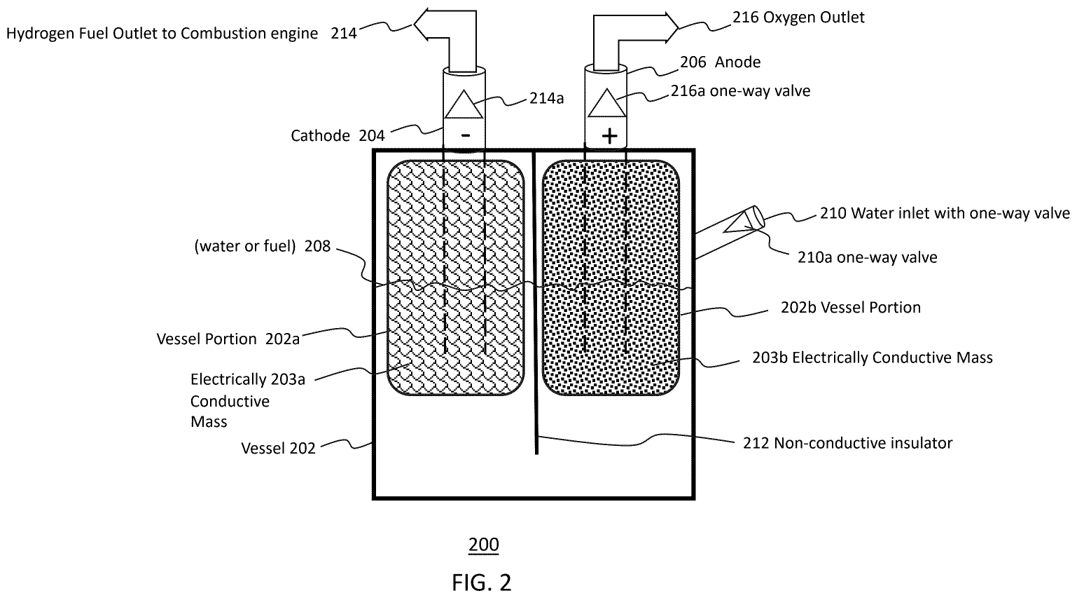

In some embodiments with further reference to the system 200 of FIG. 2, the first electrode 206 is an anode, the second electrode 204 is a cathode, the fuel 208 is water, and a vessel 202 includes a first vessel portion 202a substantially electrically isolated from a second vessel portion 202b using a non-conductive barrier 212, where the at least one electrically conductive mass 203a is coupled to the cathode (204) within the first vessel portion 202a to enable hydrogen fuel generation and where a second electrically conductive mass 203b is coupled to the anode (206) within the second vessel portion 202b to enable oxygen generation.

In some embodiments, the first electrode 206 is an anode, the second electrode 204 is a cathode, the fuel 108 is water, and the cathode is further configured to serve as a portion of a hydrogen fuel outlet 214 and the anode is further configured to serve as an oxygen outlet 216. In some embodiments, the vessel 202 can be made of a non-conductive material.

In some embodiments, the system further includes a one-way valve (214a, 216a, and 210a) respectively for each of the hydrogen fuel outlet 214, the oxygen outlet 216, and the fuel source inlet 210.

In some embodiments, with further reference to the system 300 of FIG. 3A, the hydrogen fuel injection system (100, 150 or 200 as shown in FIGS. 1A, 1B, or 2) is a portion of a hydrogen fuel injection combustion engine system 300 including a fuel tank 302 that supplies the hydrogen fuel injection system (100/150/200) via a pump 310, a power source 308 coupled to the hydrogen fuel injection system, a combustion engine 306 coupled to the hydrogen fuel injection system, and a processor 304 or ECM coupled to the pump 310, power source 308, and hydrogen fuel injection system, where the processor 304 regulates at least the pressure provided by the pump 310 and the current or voltage provided by the power source 308 to the hydrogen fuel injection system.

In some embodiments, the hydrogen fuel injection combustion engine system 350 as shown in FIG. 3B can further include an exhaust condensation chamber 314 coupled to a second pump that feeds condensation back to the fuel tank 302 and where the processor 304 is further coupled to the second pump 312 to control the pressure provided by the second pump 312. In some embodiments, the exhaust condensation chamber 314 can further include a pressure regulated one-way valve 316.

In some embodiments, a hydrogen fuel injection system (of FIG. 3A or 3B) can alternatively use the fuel injection systems from FIGS. 1A, 1B, or 2 that can include a vessel 102 as shown in FIG. 1A or 1B or vessel 202 as shown in FIG. 2 having a fuel source inlet for receiving fuel from a fuel source containing water, a first electrically conductive mass (103/203 as shown in FIG. 1A/1B or FIG. 2) within a first vessel portion (102 or 202a) of the vessel for providing increased surface area to the fuel, a second electrically conductive mass (203b in the case of FIG. 2) within a second vessel portion 202b of the vessel (202b), a cathode 104/204 coupled to the first electrically conductive mass 103/202a, and an anode 116/206 coupled to the second electrically conductive mass (203b in the case of FIG. 2). In some embodiments, the cathode and anode are arranged and constructed to break down the water into hydrogen and oxygen when a power source 308 applies a voltage across the cathode and anode where the system (100,150, or 200) further includes a non-conductive barrier 112/212 that at least partially isolates the cathode 104/204 from the anode 116/206, a first outlet 116a/214 at least formed partially from the cathode (204) and coupled to the first vessel portion (102/202a) serving as a hydrogen fuel outlet to a combustion engine 306, and a second outlet 216 (in the case of FIG. 2) at least formed partially from the anode 206 and coupled to the second vessel portion 202b serving as an oxygen outlet.

In some embodiments, the first vessel portion 202a and the second vessel portion 202b are porous. Thus, the porous vessel portions can allow water or other water mixtures serving as fuel to penetrate within the vessel portions and further contact the respective electrically conductive masses 203a and 203b respectively. Since the conductive masses provide greater surface area, the electrolysis operation can provide greater production of hydrogen and oxygen accordingly.

In some embodiments with reference to FIG. 3A, a hydrogen fuel injection combustion engine system 300 can include a fuel tank 302 configured for holding fuel containing at least water, a hydrogen fuel injection system (100, 150 or 200) coupled to the fuel tank 302 where the hydrogen fuel injection system generates hydrogen via electrolysis, a pump 310 coupled between the fuel tank 302 and the hydrogen fuel injection system and configured to drive fuel from the fuel tank 302 to the hydrogen fuel injection system, a power source 308 coupled to the hydrogen fuel injection system, a hydrogen fuel combustion engine 306 coupled to the hydrogen fuel injection system, and a processor 304 (or ECM) coupled to the pump 310, the power source 308, and the hydrogen fuel injection system, where the processor 304 regulates at least the pressure provided by the pump 310 and the current or voltage provided by the power source 308 to the hydrogen fuel injection system (100/150/200).

In some embodiments, a hydrogen fuel injection combustion engine system 350 as shown in FIG. 3B can further include an exhaust condensation chamber 314 coupled to a second pump 312 that feeds condensate or condensation back to the fuel tank 302 and where the processor 304 is further coupled to the second pump 312 to control the pressure provided by the second pump 312.

In some embodiments with reference to FIGS. 1A, 1B, 2, and 3A or 3B, the hydrogen fuel injection system 300 includes an anode (116/206) and a cathode (104/204), and where at least a fuel outlet (116a or 214) formed from the cathode or the anode of the hydrogen fuel injection system at least partially serves as an inlet to the hydrogen fuel combustion engine 306.

In some embodiments, the hydrogen fuel injection system 200 (of FIG. 2) used for the system 300 or 350 of FIG. 3A or 3B) can further include a vessel 202 having a fuel source inlet 210 for receiving fuel from the fuel tank 302 containing water, a first electrically conductive mass 203a within a first vessel portion 202a for providing increased surface area to the fuel, a second electrically conductive mass 203b within a second vessel portion 202b, a cathode 204 coupled to the first electrically conductive mass 203a, an anode 206 coupled to the second electrically conductive mass 203b, where the cathode and anode are arranged and constructed to break down the water into hydrogen and oxygen when a power source 308 applies a voltage across the cathode and anode. The hydrogen fuel injection system 200 can further include a non-conductive barrier 212 that at least partially isolates the cathode from the anode, a first outlet 214 at least partially formed from the cathode 204 and coupled to the first vessel portion 202a serving as a hydrogen fuel outlet to provide (hydrogen) fuel the hydrogen combustion engine 306, and a second outlet 216 at least partially formed from the anode 206 and coupled to the second vessel portion 202b serving as an oxygen outlet 216.

Although certain structures and materials have been disclosed with respect to the embodiments described in the figures, note that the scope of the embodiments are not limited to such structures and materials. For example, the vessels 102 or 202 can be made of a stainless steel (or equivalent) vessel 102 that can serve as a ground that can have a separate cathode 104 coupled thereto. In certain embodiments the vessel 102 or 202 can be made of a conductive material. In other embodiments, the vessel 102 or 202 does not necessarily need to be made of a conductive material.

The vessel 102 can have two parts in certain embodiments that are substantially electrically isolated to allow for the electrolysis process of water. The isolation can be achieved using a non-conductive insulator such as insulator 112 (or 112a or 212) made of rubber or glass or other insulating material that can adequately withstand the operating temperatures of the system. The insulator should substantially separate the anode 106 from the cathode 104 so that they do not directly connect.

In some embodiments as shown in system 100 or 150 of FIG. 1A or 1B respectively, one portion 106 of an electrode (anode) 116 can also made of stainless steel mesh (or equivalent material) with a great amount of surface area (ex. stainless steel porous spongelike mass attached to and encompassing the stainless steel outlet tube 116a, or a stainless wire brush attached to and encompassing the stainless steel outlet tube 116a). The anode 116 can also serve as the outlet tube 116a for hydrogen and oxygen gas that escapes outward from the vessel 102 via a one-way valve 114. Generally, the system 100 or 150 will include a tube on the upper side of the vessel that captures the hydrogen and oxygen gases which will serve as a fuel outlet 116a that can be directly attached to a combustion chamber of a combustion engine. The tube or outlet 116a will inject the hydrogen and oxygen directly into a combustion chamber of a combustion engine 306 (see FIG. 3) which will then combust causing the engine to run. The combustion engine can generally be part of a vehicle, generator, heating unit, or boiler that can provide a drive to a machine.

The water inlet 110 having a one-way valve 110a that can bring in water from a water source.

Voltage (can be variable depending on application, this will be regulated by an electronic computer module (ECM) (304) or alternatively using high voltage ignition coil and can be applied to the electrodes which will cause water to break down into Hydrogen and Oxygen. The operational voltages can vary widely and can typically range from 3V to 24V. The pressures generated by the pumps in the system can also vary widely and can typically range from 7 to 60 psi in certain applications or embodiments.

The system 200 of FIG. 2 can include in some embodiments a vessel 202 that can be at least partially made of a non-conductive heat and pressure resistant material in the form of a container or containers. The vessel 202 will be electrically isolated to allow for the electrolysis process of water. The isolation can be achieved as previously referenced using a non-conductive insulator or barrier 212 made of rubber or glass or other insulating material that can adequately withstand the operating temperatures of the system 200. The insulator 212 should substantially separate the anode 206 from the cathode 204.

In some embodiments as shown in FIG. 2, the insulator or non-conductive separation barrier 212 can extend from the top of the tank or vessel 202 so that the barrier will separate portions of the vessel 202 from the top and extend down approximately ⅔ to % of the depth of the tank or vessel 202 and substantially electrically isolate vessel portions 202a from vessel portion 202b.

The one part or vessel portion 202b can have an electrode (anode 206) made of stainless steel (or other suitable anode material) with a great amount of surface area (such as a stainless steel porous spongelike mass attached to and encompassing a stainless steel outlet tube, or a stainless wire brush attached to or within the tube and otherwise encompassing a stainless steel outlet tube).

The anode 206 can also serve as the outlet tube 216 for oxygen gas that escapes outward from the vessel portion 202b via a one-way valve 216a while the cathode serves as the outlet tube for hydrogen gas that escapes outward from the vessel portion 202a via another one-way valve 214a.

The vessel 202 can have one or more chambers or vessel portions (202a, 202b, etc.) that each can hold an electrically conductive mass (203a and/or 203b) as well as the fuel entering the vessel 202 and through the porous surfaces of the vessel portions 202a and 202b.

In the embodiment of FIG. 2, applied voltage (that is variable depending on the application), can be regulated by an ECM or processor 304 (see FIG. 3) or high voltage ignition coil which will be applied to the electrodes (anode 206 and cathode 204) causing water to break down into Hydrogen and Oxygen in the electrolysis process. Hydrogen will be attracted to the cathode 204 (negative charge electrode) and Oxygen will be attracted to the anode 206 (positive charge electrode). A tube 214 can catch the escaping hydrogen at the cathode 204. The tube or outlet 214 will inject the hydrogen directly into the combustion chamber of a combustion engine 306 (see FIG. 3) which will then combust causing the engine to run. A tube 216 catches the Oxygen at the anode 206. The outlet tube 216 or 206 (anode) can allow the oxygen to bleed off (this tube will have a one-way valve 216a so as to not allow outside air into the unit). Alternatively, the oxygen can be funneled into another chamber for other uses.

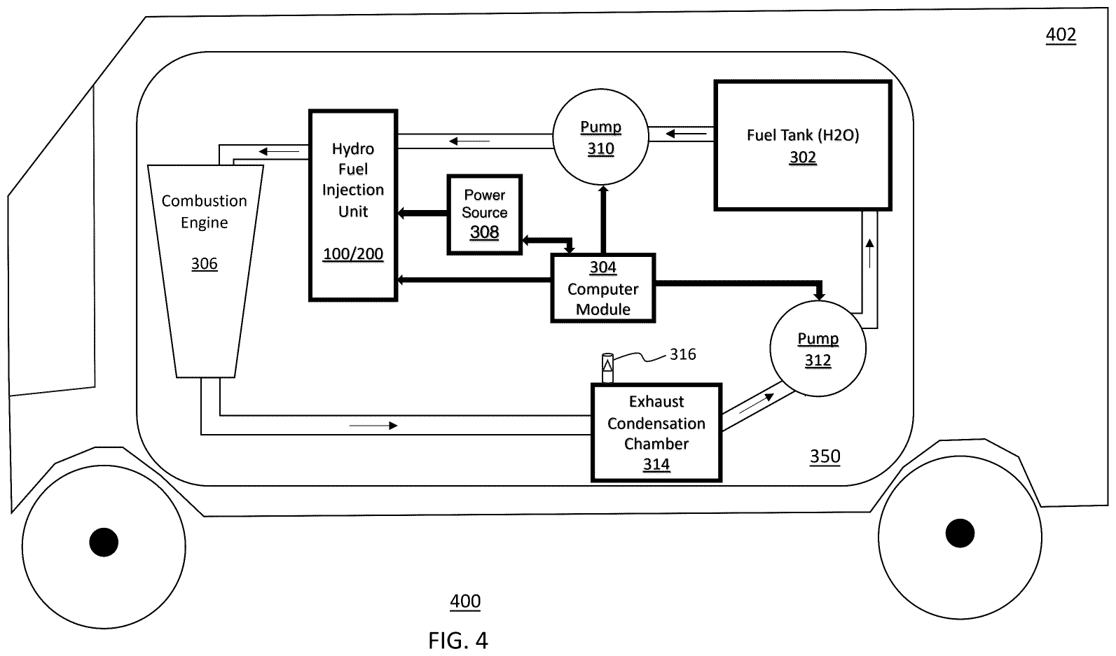

In summary, the hydrogen fuel injection systems in FIGS. 1A, 1B, or 2 can by used by a a hydrogen fuel injection and combustion engine system 300 or 350 as shown in FIG. 3A or 3B. The system 300 and 350 can in turn be used by a machine such as a vehicle 400 shown in FIG. 4. The Hydrogen Fuel Injection systems (100 or 200) in conjunction with the other components relating to the systems of a combustion engine 306 which can further include a fuel tank 302 containing water (fuel) or other water mixture, a variable pressure fuel pump 310 that is monitored and regulated by the Electronic Computer Module or ECM or processor 304. The Hydrogen Fuel Injection system, power supply 308, and pumps can be monitored and regulated by the processor 304. The Electronic Computer Module or processor 304 monitors and regulates the system components to ensure maximum efficiency and performance.

In terms of equating the use of water as a fuel source relatively to a typical gasoline or diesel combustion engine, note that gasoline puts out approximately 125,000 BTU's/gallon of energy and 1 gallon of gasoline weighs approximately 6 lbs. 11b of gasoline (⅙ of a gallon) puts out approximately 20,833 BTUs of energy. 1 lb of hydrogen puts out approximately 51,628 BTUs of energy. There is approximately 5.6 liters of Hydrogen gas/gallon of water.

Further note that a 318 cu in engine four cylinder diesel tractor uses 4.8 gal/hour of diesel fuel at operating speed. 4.8 gal divided by 318 cu in gets 0.015 gal per cu in/hour of fuel consumption. In certain instances, this is equivalent to 0.00025 gal/min at 2000 RPMs and 0.00000012 gal/cu in per cylinder fire.

A 99.7 cu in two cylinder engine gasoline tractor uses 1.3 gal/hour of gasoline at operating speed. 1.3 gal divided by 99.7 cu in gets 0.013 gal per cu in/hour of fuel consumption. This is equivalent to 0.00021 gal/min at 1400 RPMs and 0.00000015 gal/cu in per cylinder fire.

A 319 Cu in engine eight-cylinder chevy truck uses 3 gal/hour of gasoline at operating speed. 3 gal divided by 319 cu inches gets 0.0094 gal per cu in/hour of fuel consumption which is equivalent to 0.00015 gal/min at 1500 RPMs which is 0.0000001 gal/cu in per cylinder fire.

Although these engines are very different in several aspects including the number of cylinders, the type of fuel used, and the overall displacement, the emissions components vs no emissions components, yet the broke down fuel consumption per cubic inch/hour is very similar. Based on the BTUs/lb, the systems herein would approximately need 2 times the amount of hydrogen into a cylinder as indicated for the diesel and gasoline engines noted above. According to the US Dept of Energy 2.2 lbs of Hydrogen is equivalent to 1 gallon of gasoline.

Conceptually, the hydrogen fuel injection system can generate hydrogen as needed in a vehicle or for a heating unit, generator or boiler. It can essentially serve as a fossil fuel replacement. In the case of a vehicle, the generation of hydrogen “on the fly” provides the added safety aspect that the vehicle does not necessarily need to carry excess volatile hydrogen fuel in a tank.

Generally, it can take less than 3V to produce hydrogen in an electrolysis process. Such a system can utilize a 12V or 24V battery for example and alternator to provide an adequate amount of voltage and current to the hydrogen fuel injection system. As the system is computer controlled using the ECM or processor 304, the processor 304 can regulate the battery or energy source applied to the electrolysis process, the water or fuel flowing into the hydrogen fuel injection system 100, 150 or 200 via a pump 310. Typical pressure levels can likely range anywhere from 7 to 60 pounds per square inch or PSI. The systems 100, 150, 200, 300, or 350 can also implement dynamic tuning to correspondingly provide a predetermined RPM for a combustion engine that corresponds to an amount of consumption of hydrogen as is done with fossil fuel engines.

In some embodiments with reference to any of the embodiments, the various components can be arranged and configured to be in any number of parameters, positions and sizes as required for a particular embodiment. Some embodiments with smaller dimensions or parameters would likely be better suited for portable embodiments.

In interpreting the present disclosure and the claims, references of the form “A and/or B” encompass any and every combination and subcombination of the elements A and B, namely any or all of the following: (i.) A, (ii.) B, (iii.) A or B, and (iv.) A and B. References of the form “A, B, and/or C” likewise encompass any and every combination and subcombination of elements A, B, and C). Where the present disclosure or any of the claims may recite “a” or “a first” item or the equivalent thereof, such disclosure includes one or more such items and does not require or exclude two or more such items. Numerical or ordinal terms such as “first”, “second”, “third” etc. when used to refer to items are used solely to identify the items, and do not require or limit the number of such items elements and do not indicate, require or limit a particular position or order of such items unless expressly and clearly stated otherwise.

Descriptions made with reference to “embodiment”, “embodiments”, “some embodiments”, “an embodiment”, “preferred embodiment”, “other embodiments”, “alternative embodiments”, “various embodiments” or the like mean that the description is applicable to at least one embodiment but not necessarily all embodiments. The terms “comprising”, “including”, “having”, and the like, as used with respect to one or more embodiments, are synonymous. In some cases, features, items, steps or other subject matter are described herein as being optional or using terms such as “optional” or “optionally”. However, lack use of such terms in connection with the description of any other features, items steps or other subject matter does not in any way mean or imply that such other features, items steps or other subject matter are required or are not optional.

As an aid to understanding, various actions, operations or steps may sometimes be presented herein or described herein in sequence. However, the order of the description or written presentation herein is not to be construed to mean or imply that such must necessarily occur in a corresponding order or sequence unless otherwise expressly and clearly stated or logically essential. Some actions, operations or steps may permissibly be performed in an order or sequence other than the order of their description or written presentation herein unless otherwise expressly and clearly stated or logically essential. Unless otherwise expressly and clearly stated or logically essential. Unless otherwise expressly and clearly state or logically essential, actions, operations or steps described herein may be combined or divided. Unless otherwise expressly and clearly stated or logically essential, any description herein of any one or more actions, operations or steps does not preclude any one or more other preceding, succeeding and/or intervening actions, operations or steps irrespective of whether or not such preceding, succeeding and/or intervening actions, operations or steps are described or disclosed herein.

Unless otherwise expressly and clearly stated or logically essential, any illustration, description, or reference herein of any one or more items, structures or elements being “connected to”, “coupled to”, “joined to”, “joined with”, “attached to”, “mounted to”, “mounted in”, or “secured to” any one or more other specified items, structures or elements shall not be construed to preclude such connection, coupling, joint, attachment, mounting or securement being either made indirectly, by way of one or more other specified or unspecified items structures or elements, or being made directly.

Unless otherwise expressly and clearly stated or logically essential, any illustration, description, or reference herein of any one or more items, structures, or elements “adjoining”, any one or more other specified items, structures or elements, shall be construed to permit that such may adjoin either direct or indirectly. The term “adjoining” permits, but does not require, preclude the presence of items, structures or elements interposed between those describes as adjoining. Unless otherwise expressly and clearly stated or logically essential, any illustration, description, or reference herein to any one or more items, structures or elements being “beneath”, “below”, “above”, “behind”, “in front of”, “between”, “under”, “over”, “in”, “within”, “outside”, “inside”, any one or more other specified items, structures or elements and/or any other prepositions or prepositional phrases shall construed in a manner which permits, but does not require, contact or immediacy and any and all other prepositions and/or prepositional phrases shall be construed in that same manner.

As used herein, the term “material” encompasses, without limitation, unblended materials having a single constituent, blended materials having two or more constituents, composite materials, homogeneous materials and non-homogeneous materials.

While the embodiments have been described with reference to various preferred embodiments, it will be understood by those skilled in the art that various changes may be made and equivalents substituted for elements thereof without departing from the scope of the embodiments and that modifications may be made to adapt to a particular situation or application of the embodiments without departing from the scope. The embodiments within the scope of the claims are not limited to the particular embodiments disclosed. Rather, the claims cover all embodiments which are within the scope of the claims, either literally or under the Doctrine of Equivalents.

1. A hydrogen fuel injection system, comprising:
a vessel having a fuel source inlet for receiving fuel from a fuel source;
at least one electrically conductive mass within the vessel for providing increased surface area to the fuel;
an first electrode having a first polarization coupled to the at least one electrically conductive mass;
a second electrode having an opposite polarization from the first polarization and coupled to the at least one electrically conductive mass, wherein the first electrode and second electrode are arranged and constructed to break down the fuel into hydrogen and oxygen when a power source applies a voltage across the first electrode and second electrode,
a non-conductive barrier that at least partially isolates the first electrode from the second electrode; and
at least a first outlet coupled to the vessel serving as a hydrogen fuel outlet to a combustion engine.

2. The hydrogen fuel injection system of claim 1, wherein the first electrode is an anode and the fuel is water.

3. The hydrogen fuel injection system of claim 1, wherein the second electrode is a cathode and the fuel source is water.

4. The hydrogen fuel injection system of claim 1, wherein the first electrode is an anode, the second electrode is a cathode, and the fuel is water.

5. The hydrogen fuel injection system of claim 1, wherein the first electrode is an anode, the second electrode is a cathode, and the fuel is water and wherein the vessel is conductive and the cathode is electrically coupled to the vessel.

6. The hydrogen fuel injection system of claim 1, wherein the first electrode is an anode, the second electrode is a cathode, and the fuel is water and wherein at least the first fuel outlet is formed from the anode.

7. The hydrogen fuel injection system of claim 6, wherein the first fuel outlet further includes a one way valve only allowing fluid out of the first fuel outlet.

8. The hydrogen fuel injection system of claim 1, wherein the at least one electrically conductive mass is a porous conductive material.

9. The hydrogen fuel injection system of claim 1, wherein the at least one electrically conductive mass is a porous conductive anode material.

10. The hydrogen fuel injection system of claim 1, wherein the first electrode is an anode, the second electrode is a cathode, and the fuel is water, wherein the vessel comprises a first vessel portion substantially electrically isolated from the a second vessel portion using the non-conductive barrier, and wherein the at least one electrically conductive mass is coupled to the cathode within the first vessel portion to enable hydrogen fuel generation and wherein a second electrically conductive mass is coupled to the anode within the second vessel portion to enable oxygen generation.

11. The hydrogen fuel injection system of claim 1, wherein the first electrode is an anode, the second electrode is a cathode, and the fuel is water, and wherein the cathode is further configured to serve as a portion of a hydrogen fuel outlet and the anode is further configured to serve as an oxygen outlet.

12. The hydrogen fuel injection system of claim 11, wherein the system further comprises a one way valve for each of the hydrogen fuel outlet, the oxygen outlet and the fuel source inlet.

13. The hydrogen fuel injection system of claim 1, wherein the system is a portion of a hydrogen fuel injection combustion engine system comprising a fuel tank that supplies the hydrogen fuel injection system via a pump, a power source coupled to the hydrogen fuel injection system, a combustion engine coupled to the hydrogen fuel injection system, and a processor coupled to the pump, power source, and hydrogen fuel injection system, wherein the processor regulates at least the pressure provided by the pump and the current or voltage provided by the power source to the hydrogen fuel injection system.

14. The hydrogen fuel injection system of claim 13, wherein the hydrogen fuel injection combustion engine system further comprises an exhaust condensation chamber coupled to a second pump that feeds condensation back to the fuel tank and wherein the processor is further coupled to the second pump to control the pressure provided by the second pump.

15. A hydrogen fuel injection system, comprising:
a vessel having a fuel source inlet for receiving fuel from a fuel source containing water;
a first electrically conductive mass within a first vessel portion for providing increased surface area to the fuel;
a second electrically conductive mass within a second vessel portion;
a cathode coupled to the first electrically conductive mass;
an anode coupled to the second electrically conductive mass, wherein the cathode and anode are arranged and constructed to break down the water into hydrogen and oxygen when a power source applies a voltage across the cathode and anode,
a non-conductive barrier that at least partially isolates the cathode from the anode;
a first outlet at least formed partially from the cathode and coupled to the first vessel portion serving as a hydrogen fuel outlet to a combustion engine; and
a second outlet at least formed partially from the anode and coupled to the second vessel portion serving as an oxygen outlet.

16. A hydrogen fuel injection system of claim 15, wherein the first vessel portion and the second vessel portion are porous.

17. A hydrogen fuel injection combustion engine system comprising:
a fuel tank configured for holding fuel containing at least water;
a hydrogen fuel injection system coupled to the fuel tank, wherein the hydrogen fuel injection system generates hydrogen via electrolysis;
a pump coupled between the fuel tank and the hydrogen fuel injection system and configured to drive fuel from the fuel tank to the hydrogen fuel injection system;
a power source coupled to the hydrogen fuel injection system;
a hydrogen fuel combustion engine coupled to the hydrogen fuel injection system; and
a processor coupled to the pump, the power source, and the hydrogen fuel injection system, wherein the processor regulates at least the pressure provided by the pump and the current or voltage provided by the power source to the hydrogen fuel injection system.

18. The hydrogen fuel injection combustion engine system of claim 17, wherein the hydrogen fuel injection combustion engine system further comprises an exhaust condensation chamber coupled to a second pump that feeds condensation back to the fuel tank and wherein the processor is further coupled to the second pump to control the pressure provided by the second pump.

19. The hydrogen fuel injection combustion engine system of claim 17, wherein the hydrogen fuel injection system includes an anode and a cathode, and wherein at least a fuel outlet formed from the anode of the hydrogen fuel injection system at least partially serves as an inlet to the hydrogen fuel combustion engine.

20. The hydrogen fuel injection combustion engine system of claim 17, wherein the hydrogen fuel injection system comprises:
a vessel having a fuel source inlet for receiving fuel from the fuel tank containing water;
a first electrically conductive mass within a first vessel portion for providing increased surface area to the fuel;
a second electrically conductive mass within a second vessel portion;
a cathode coupled to the first electrically conductive mass;
an anode coupled to the second electrically conductive mass, wherein the cathode and anode are arranged and constructed to break down the water into hydrogen and oxygen when a power source applies a voltage across the cathode and anode,
a non-conductive barrier that at least partially isolates the cathode from the anode;
a first outlet at least partially formed from the cathode and coupled to the first vessel portion serving as a hydrogen fuel outlet to the hydrogen combustion engine; and
a second outlet at least partially formed from the anode and coupled to the second vessel portion serving as an oxygen outlet.
